(19) United States
(12) Patent Application Publication
(10) Pub. No.: US 2011/0026575 A1
(43) Pub. Date: Feb. 3, 2011

(54) Method and Apparatus For Enhanced Performance and Crosstalk Measurement in a MIMO Communication System

(75) Inventors: Eldad Shalom, Gan-Yavne (IL); Yuval Shalev, Kfar-Saba (IL)

Correspondence Address: The Law Office of Michael E. Kondoudis, 888 16th Street, N.W., Suite 800, Washington, DC, 20006, US

(73) Assignee: Obimey Ltd., Kfar-Saba (IL)

(21) Appl. No.: 12/936,208

(22) PCT Filed: Apr. 5, 2009
(86) PCT No.: PCT/IL09/00358

§ 371 Date: Oct. 3, 2010

Related U.S. Application Data
(60) Provisional application No. 61/041,598, filed on Apr. 2, 2008.

(51) Int. Cl. H04B 17/00

(52) U.S. Cl. 375/227; 375/285

(57) ABSTRACT

The present invention comprises a system and method for reduction of the influence of crosstalk, increase in and control over quality of service, increase in stability and reduction of power use in a system having multiple transmission lines. A novel crosstalk measurement method is introduced. Knowing the crosstalk, various algorithms may be employed, for example to reduce or eliminate its effects in order to guarantee a bit error rate equal to or less than the maximum allowed for each line. Similar methods are provided to minimize power consumption, or maximize related measures of line performance. Systems, devices, methods and techniques are provided that allow communication system to adapt transmission power margin, power spectral densities, and the like dynamically to changing subscriber's application needs in MIMO systems.

### FIELD OF THE INVENTION

The present invention relates to a method and apparatus for improving the performance characteristics of a communication system having multiple parallel channels with some degree of crosstalk between them, and for determining this crosstalk as well.

### BACKGROUND OF THE INVENTION

Transmission channels (such as unshielded twisted-pair (UTP) copper phone lines) generally suffer from noise due to various sources such as crosstalk, which is exacerbated when many lines are bundled together in a cable that travels long distances. In the prior art a variety of systems for improving performance of transmission channels by reducing such noise have been proposed.

Digital data is today often carried using ‘digital subscriber line’ (DSL) technologies which provide high bitrate over existing telephone lines, transmitted through some form of modem. Asymmetric DSL (ADSL), for example uses bandwidth of 1.1 Mhz, ADSL2+ uses 2.2 Mhz, and VDSL2 uses bandwidth of up to 30 Mhz, which constitute a several orders-of-magnitude increase over the original audio bandwidth of 4 KHz carried over the same lines. Most DSL technologies today divide the available frequency spectrum into a number of distinct subbands (often referred to as subcarriers, tones, or bins) on which information is transmitted simultaneously. This so-called discrete multitone (DMT) technology sends information over each tone (or sub-carrier) independently.

The channel condition is determined during special calibration periods called training and initialization phases of the modems at each end of the subscriber line. The initial power, margin (extra signal-to-noise ratio beyond that strictly necessary) and other operational characteristics of the pair are also determined before full operation of the modems.

Using line characteristics and predefined power restrictions (namely, the maximum power spectral density or PSD for the specific modem, and other possible local restrictions), the modems compute the bit loading or transmission bit loading (bᵢ, or number of bits per bin i) for each bin, gains (gᵢ) for each bin, and margin for each bin. Bit assignment and gains can be modified during regular operation of the modem using several processes known in the prior art such as “bit swapping”, SRA (Seamless Rate Adaptation) methods, or RRA™ (Rapid Rate Adaptation).

Many types of noise may increase the error rate of data transmitted by DSL systems, such thermal noise, impulse noise due to interference from adjacent lines (crosstalk), and many more. To prevent or reduce such bit errors, systems generally utilize extra transmission power that improves the margin above a given pre-calculated signal to noise ratio (SNR), hence assuring compliance with an acceptable error rate.

The DSL transmission environment is traditionally thought of as a single user environment where PSD constraints are used to limit the worst-case crosstalk emissions. However, in practice a single cable often serves tens to hundreds of homes, within which twisted pairs of copper wire serving modems or telephones from different homes are bundled together. In the bundled environment, because of the physical proximity of twisted pairs over long paths, the electromagnetic radiation emitted by each line will bleed into the adjacent lines to some degree. Such interference is called crosstalk and is a major issue in data subscriber line (DSL) systems. DSL experiences two types of crosstalk. Each line has two modems (or other transmitters) attached to it, one on each end. Near end crosstalk (NEXT), is generated by neighboring transmitters on the same side of the receiver, while far end crosstalk (FEXT), is generated by transmitters on the opposite side of the receiver (at the far end). Due to the large number of bundled lines, the DSL environment is more accurately modeled as a multiuser environment. In ADSL and VDSL technologies, NEXT is overcome using FDD (Frequency Division Duplex), which separates frequencies of transmitter and receiver on the same side of the modem. However, the NEXT from other services, not spectrally matched, will still interfere. Furthermore, by limiting the available transmission or receiving frequencies, the total data transmission rate will necessarily be lowered.

### Power Control

Several schemes have been proposed in order to efficiently control power in a communication system. Generally speaking, DSL spectrum management systems control the power spectra of various DSL services in order to limit the crosstalk between lines in the same bundle. Such systems are usually composed of three stages:
1. Collecting operational data of each line. Examples for such operational data are loop and crosstalk transfer functions, bitrate and SNR of the link, and loop topology.
2. Analyzing these operational data in order to find optimal spectrum distribution for the lines. Criteria for optimality can be for example maximum aggregate data rates of the mutually interfering DSL modems, or achieving the individual target rate of each line with best SNR. This analysis can be done by a centralized controller, such as DSM center. Alternatively, methods for decentralized processing have also been suggested. Analyses can also use additional information on the line such as historical data relating to prior performance of the modem pair and prior SNR compliance. Additional historical input to the analysis may be the transmit power levels previously used by the modem pair, data rates previously used by the modem pair, and/or data regarding previous error behavior of the modem pair.
3. Generating the required margin-related changes to the modems. Examples for such margin-related values are PSD value for every subcarrier, shaped spectral mask (maximum power limit as function of frequency, as required e.g. by FCC regulation in the US), and bitloading limits In some cases, preference bands can be imposed to direct modems to favor and/or avoid certain frequencies in the modem's usable band.

Systems and methods to dynamically control these margin-related parameters have also been suggested.

Taking into Consideration the Required QoS for Specific Application

‘Triple play’ refers to delivery of voice, video, and data services to retail customers, often over a single transmission line at some stage. These three types of traffic have very different requirements, and stress the network in unique ways. Nevertheless, the network as a whole must be able to efficiently carry all traffic types.

In general, each service in the network would benefit from a tailored policy that would take into account its required quality of service (QoS), specifically the latency, bitrate, and error rate.

For example, voice conversation requires extremely low latency (delay time). Any delay or gap in transmission is instantaneously noticeable by the customer. Latency is perhaps even more important than the sound quality of voice; a few dropped packets is more acceptable than any form of packet delay.

On the other hand, video presents a different set of challenges. With video, far larger amounts of data are transported to the customer premises and ultimately to the television set or other video device. Small changes in latency go unnoticed and are typically smoothed over by constant buffering in the settop box (STB) at the customer premises. Home video delivery is not a real-time application like video conferencing, which has the same latency requirements as voice calls. The biggest challenge with sending large amounts of data over a long period of time is ensuring every frame is delivered. If not, the picture can pixelate, freeze or disappear altogether. Thus minimizing dropped packets in this case is more important than latency.

Internet or data is the least stringent in terms of service level parameters when compared to voice and video. If a few frames are lost, traditional TCP/IP mechanisms manage data restoration adequately. In many cases, the bottleneck is not with the Ethernet service, but with the ISP and Internet servers themselves. With data services, the challenge is ensuring minimum download speeds and service up time.

Hence, in the network, different applications will benefit from receiving different treatment (like different queues in router/switch/DSLAM (digital subscriber line access multiplexers), the use of intelligent priority-marking algorithms, etc). For example, a high priority voice packet arriving to a DSLAM should be delivered towards its destination before a lower priority data packet is. Practically this means that, as the DSLAM does not allocate enough bandwidth to simultaneously transmit both packets, the data packet is delayed on behalf of the video packet. Since the data application is not sensitive to jitters, the QoS is not affected from the user's point of view.

FIG. 1 illustrates a common installation of DSL lines in prior art. A DSLAM/MSAM 120 is located in a Central Office (CO) or a Remote Terminal (RT) 130. The DSLAM provides data, telephony, television, and possibly other services to the customer premises equipment (CPE) 150. The services are transmitted to the subscriber's equipment 150 through twisted copper pairs 140 bundled together. Normally, several twisted pairs are bundled together, in a cable 110.

FIG. 2 shows the known phenomena of far end crosstalk (FEXT) 250 and near-end crosstalk (NEXT) 260 between bundled lines (240-1, 240-2, 240-3) inside a cable 230. Since crosstalk may in fact be the dominant noise source in such a system, it behooves the system designed to take this effect into account.

We now survey the prior patent art and point out shortcomings therein. U.S. Pat. No. 7,158,563 provides a method involving collecting information about line, signal and interference characteristics of the communication lines in a bundle, and using this information to create a model of the transmission characteristics. Using this model transmission power is adjusted to decrease interference. However this system does not take into account the type of service (telephone, video, data, etc.) being transferred on the various lines, instead defining target rates for each line. By limiting the analysis to use of target rates without taking into account further requirements (such as changing BER during line activity), the method is blind to considerations that may ultimately have more importance than simple transmission rates. The method reacts to variable data-rate on a loop and not to variable quality of service (QoS) requirements of that loop. It mentions that every subscriber can have a different rate and different service level, which in this case refers to different service level agreements with the telephone operator, in effect a static agreement.

Various schemes have also been suggested (e.g. EP0753948, U.S. Pat. No. 6,775,320, U.S. Pat. No. 6,778,596B1) to deal with best allocation of data into DMT carriers by looking at the data application and noise at each bin and allocating a group of data into a group of carriers such that requirements for SNR, BER, etc for each data application will be met. Some of these methods even suggest dynamic allocation of data into bins. Nevertheless, all these methods still deal with optimal carrier allocation for traffic on a single line, and don't solve the global problem of dynamic allocation of traffic in MIMO systems.

U.S. Pat. No. 6,778,596B1 specifically speaks about changing modem parameters according to changing application (data, voice, video, etc). This dynamic change does not consider the influence of changing crosstalk due to changing operational mode of the line, and is therefore a suboptimal solution.

Similarly, methods to reduce power in certain frequency bins where the requested data rate is less than the maximum data rate achievable on the line were suggested by U.S. Pat. No. 6,259,746. However this system similarly fails to take into account the fact that different lines have different amounts of crosstalk, and that the total data rate in a cable will benefit from global consideration of all the different crosstalks and data services involved.

U.S. Pat. No. 7,177,419 deals with measuring crosstalk by means of using a special REVERB pattern on one line while measuring the response on other lines. However this method cannot be used during active service of the lines (SHOWTIME) since all modems must remain silenced while one sends the test pattern.

US 20050213714 provides a method for crosstalk measurement. Two methods are presented: disruptive and non disruptive. The disruptive measurement is accomplished by transmitting a sequence on one modem, in bins, while all the other modems listen (receive) on all bins. Obviously this method may measure crosstalk at high sensitivity but requires stopping transmission entirely or almost entirely during the crosstalk measurement.

The non-disruptive methods can, for example, “increase the gᵢ's of one particular system and check which other system will fall in SRA/Bit swap mode to update its bit loading. Similarly, for some embodiments, non-disruptive, passive methods do not generate extra-signals/power but rather use the cross correlation between the residual error at each frequency and the NEXT/FEXT source. For some embodiments, non-disruptive, active methods can, for example, increase the gᵢ's of one particular system and check which other system will fall in SRA/Bit swap mode to update its bit loading. Similarly, for some embodiments, non-disruptive, passive methods do not generate extra-signals/power and may use the cross correlation between the residual error at each frequency and the NEXT/FEXT source.” However it should be noted that by changing gᵢ's on one modem and detecting the influence (as seen in bit swapping) on others, a true crosstalk measurement has not actually been performed, but rather only an estimation of which pair interferes another and in what bins. The second non disruptive method uses cross correlation measurements.

As for the power control, “A traffic based power swap scheme may comprise a scheme in which the CO monitors the data traffic, payload activity, on all the ports and based on the activities it re-allocates the power/margin to the ports which requires the additional payload” This method actually speaks about rate adaptation and does not use traffic type information as we are (quality control and power reduction).

Another scheme proposed is “selective power swap”: “This scheme may operate similar to the above schemes, but may additionally be based on the service the customer is subscribed to”. However this method refers to application-specific data, using predefined data (static) and not real-time application information.

Hence, an improved method of measuring crosstalk and enhancing performance of transmission lines in a multi-line transmission link is still a long felt need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 illustrates a common installation of DSL lines, and interferences between lines in a bundle.

FIG. 2 further illustrates a common installation of DSL lines, and interferences between lines in a bundle.

FIG. 3 describes basic component for implementing power control system.

FIG. 4 shows DSL lines with different applications on each line.

FIG. 5 illustrates method for power control scheme.

FIG. 6 illustrates embodiment of power control scheme that optimize QoS on services.

FIG. 7 illustrates embodiment of power control scheme that maximally reduce power consumption.

FIG. 8A, B describes the cross talk measurement process including the black out process and the managed and synchronized transmitting per pair and Bin.

FIG. 9 describes the cross talk measurement process synchronization.

FIG. 10 describes the cross talk effect for an unbundled services scenario.

FIG. 11 describes an example of cross talk measurement flow.

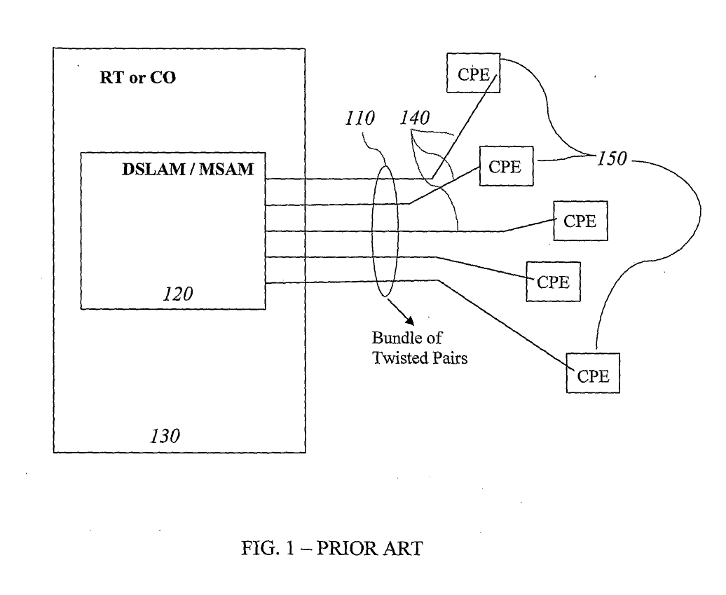

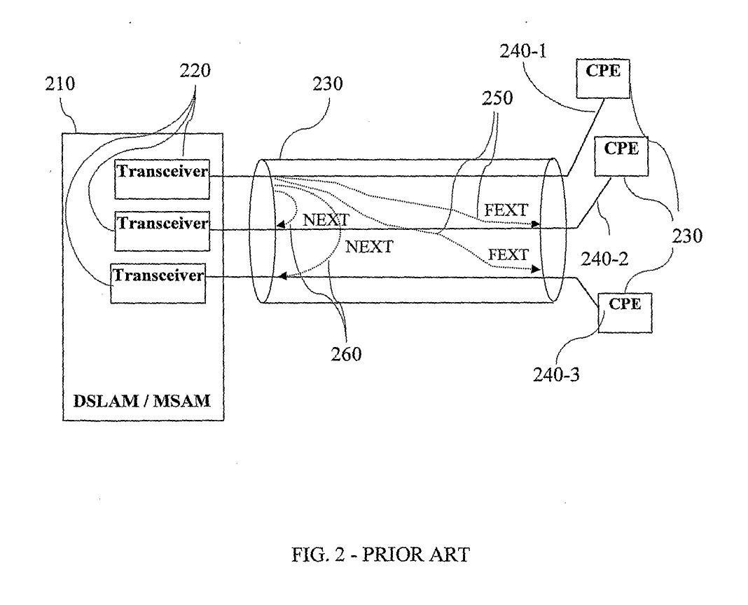

### SUMMARY OF THE INVENTION

The present invention comprises a system and method for reduction of the influence of crosstalk, increase in and control over quality of service, increase in stability and reduction of power use in a system having multiple transmission lines. First the crosstalk is quantified by transmitting along each line in turn, at each frequency bin in turn, and measuring received power on all other lines. Once the crosstalk is known this information is used in one of several ways. To minimize crosstalk, a signal-to-noise (SNR) margin or other measure of service quality is defined for each channel. The desired SNR or service quality measure is defined for each service on each line in a dynamic fashion. For example, the parameter used may be maximum bit error rate (BER), which has different target values for different services. Knowing the crosstalk, various algorithms may be employed to reduce or eliminate its effects in order to guarantee a BER equal to or less than the maximum allowed for each line. For example, starting with the channel having the worst deficit in SNR or other quality measure, the power in the most-interfering line (known from the crosstalk measurement) having the least or no deficit is reduced. This is repeated for each interfering line in descending order of interference level, until the interference in the original line is minimized or eliminated. Similar methods are provided to minimize power consumption, or maximize related measures of line performance. Systems, devices, methods and techniques are provided that allow communication system to adapt transmission power margin, power spectral densities, and the like dynamically to changing subscriber's application needs in MIMO systems.

It is within the core of the present invention that to provide a method of crosstalk reduction in a multiple input-multiple output (MIMO) packet of transmission lines comprising steps of:
a. defining a vector of target parameter values for each said transmission line based on service;
b. calculating a metric based on the deficit between said target values and actual parameter values for each said transmission line;
c. determining the crosstalk for each pair of said transmission lines;
d. varying the transmitted power spectral density (PSD) at each frequency of each said transmission line to optimize said metric;
   whereby said metric for said MIMO transmission line system is optimized taking into account said application data and said crosstalk.

It is further within scope of the invention to provide the aforementioned method wherein said varying of transmitted PSD is accomplished by means of an algorithm selected from the group consisting of: iteration, gradient descent, simplex, simulated annealing, quantum annealing, genetic algorithm, neural network, SVM, radial basis function, alpha-beta pruning, and interior point method.

It is within the core of the invention to provide a method of reducing crosstalk in a MIMO transmission line system comprising steps of:
a. collecting service data for each transmission line in said transmission line system;
b. collecting operational data for said transmission line;
c. determining the crosstalk for each pair of said transmission lines;
d. determining for each line a maximum allowed bit error rate (BER) required to maintain adequate quality of service (QoS) on said line;
e. calculating a metric function of said application data, said operational data, said maximum BER, and said crosstalk;
f. adjusting the transmitted PSD for said transmission lines to maximize said metric function;
wherein service information is utilized in addition to operational and crosstalk data to maximize said metric function.

It is further within scope of the invention to provide the aforementioned method where said step of adjusting the transmitted PSD for said transmit lines comprises steps of:
a. defining a target SNR value for each said transmission line based on said application data;
b. calculating the deficit between target and actual SNR values for each said transmission line;
c. for each line in order of largest to smallest deficit, reducing power in those bins of any other lines having deficit less than zero, without increasing the deficit of said other lines above zero;
   whereby the deficit for each line in said MIMO transmission line system is reduced taking into account said application data.

It is further within scope of the invention to provide the aforementioned method where said step of adjusting the transmit PSD for said transmit lines comprises steps of:
a. defining a target SNR value for each said transmission line based on said application data;
b. calculating the excess SNR for each bin of each line of said MIMO transmission line system;
c. for each line in order of highest to lowest excess SNR, reducing power in those bins having excess SNR, without reducing said SNR below zero;
   whereby the crosstalk interferences in said MIMO transmission line system is reduced taking into account said application data.

It is further within scope of the invention to provide the aforementioned method where said method is used for power consumption reduction.

It is further within scope of the invention to periodically repeat the entire method, whereby changes in service on lines can be taken into account.

It is further within scope of the invention to provide the aforementioned method where said step of determining the crosstalk for each pair of said transmission lines comprises steps of:
a. for each line under test in said transmission line system, selecting a set of blackout bins on said line under test;
b. decreasing transmit power to zero on said set of blackout bins on all lines except for said line under test in said MIMO transmission line system;
c. broadcasting a predetermined signal on said line under test in said bins under test;
d. measuring the received power on all lines except for said line under test in said MIMO transmission line;
e. repeating steps a-c for all lines in said MIMO transmission line system;
   whereby crosstalk measurement is achieved during showtime with only a negligible decrease of total transmission rate on said transmission lines.

It is further within scope of the invention to provide the aforementioned method where said predetermined signal is selected from a group consisting of: a showtime PSD level, a constant power level, and a periodically varying power level.

It is further within scope of the invention to provide the aforementioned method where said step of decreasing transmit power is accomplished by means selected from a group consisting of: a bin blackout message, a constant signal, or a time-varying signal.

It is further within scope of the invention to provide the aforementioned method providing a further step comprising importing crosstalk data from an external test measurement database.

It is further within scope of the invention to provide the aforementioned method providing a further step of using the embedded double-ended line test of one or more of said transmission lines.

It is further within scope of the invention to provide the aforementioned method where said step of determining the crosstalk for each pair of said transmission lines comprises a technique selected from the group consisting of: use of built in measurement functions available on one or more of said transmission lines; and use of external measurement data.

It is further within scope of the invention to provide the aforementioned method including an additional step of performing any level of dynamic signal management (DSM).

It is within provision of the invention to provide a system for reducing crosstalk in a MIMO transmission line system comprising:
a. means for collecting application data for each transmission line in said transmission line system;
b. means for collecting operational data for said transmission line;
c. crosstalk measurement means for determining the crosstalk for each pair of said transmission lines;
d. means for calculating a metric function of said application data, said operational data, and said crosstalk;
e. power control means for adjusting the transmit PSD for said transmission lines to maximize said metric function;
wherein application data is utilized in addition to operational and crosstalk data to maximize said metric function.

It is within provision of the invention to provide the aforementioned system where said power control means comprises:
a. definitions of target SNR value for each said transmission line based on said application data;
b. means for calculation of the deficit between target and actual SNR values for each said transmission line;
c. a power controller adapted to reduce power in those bins of any other lines having deficit less than zero, without increasing the deficit beyond zero, for each line in order of largest to smallest deficit,
   whereby the deficit for each line is said MIMO transmission line system is reduced taking into account said application data.

The system of claim 15 where said power control means comprises:
a. definitions of target SNR value for each said transmission line based on said application data;
b. means for calculation of the excess SNR for each bin of each line of said MIMO transmission line system;
c. a power controller adapted to reduce power in those bins having excess SNR, without reducing said SNR below zero, for each line in order of highest to lowest excess SNR;
   whereby the crosstalk interferences in said MIMO transmission line system is reduced taking into account said application data.

It is within provision of the invention to provide the aforementioned system where said means for determining the crosstalk for each pair of said transmission lines comprises:
a. means for selecting a set of bins under test on said line under test for each line under test in said transmission line system;
b. power control means adapted for decreasing transmit power to zero on said set of bins under test, on all lines except for said line under test;
c. broadcast means adapted for broadcasting a predetermined signal on said line under test in said bins under test;
d. power measurement means adapted for measuring the received power on all lines except for said line under test;
e. control means adapted for repeating steps a-c for all bins in said line, and for all lines in said transmission line system,
   whereby crosstalk measurement is achieved during showtime with only a negligible decrease of total transmission rate on said transmission lines.

It is within provision of the invention to provide the aforementioned system where said predetermined signal is selected from a group consisting of: a showtime PSD level, a constant power level, and a periodically varying power level.

It is within provision of the invention to provide the aforementioned system where said power control means is adapted to broadcast a bin blackout message.

It is within provision of the invention to provide the aforementioned system including means for performing any level of dynamic signal management (DSM).

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a method and apparatus for improved performance and crosstalk measurement in a multiple-input, multiple-output bundle of transmission lines.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘SRA’ hereinafter refers to Seamless Rate Adaptation.

The term ‘RRA’ hereinafter refers to system known as Rapid Rate Adaptation™.

The term ‘SNR’ refers to signal to noise ratio.

The term ‘DSL’ refers to data digital subscriber line.

The term ‘sub-carrier’ refers to a fundamental element of a discrete multi-tone (DMT) modulator. The modulator partitions the channel bandwidth into a set of parallel sub-channels. The center frequency of each sub-channel is a sub-carrier, onto which bits may be modulated for transmission over a channel.

The term ‘bin’ refers to an index number of a sub-carrier in a DMT modulation.

The term ‘transmission line’ refers to a medium over which signals bearing information may be transmitted, such as a copper wire.

The term ‘UTP’ refers to a transmission line composed of unshielded twisted pairs of insulated copper wire.

The term ‘crosstalk’ or ‘XT’ refers to a signal in a transmission line due to power transmission from neighboring transmission lines.

The term ‘NEXT’ hereinafter refers to near-end crosstalk, this being crosstalk between two pairs of a cable measured at the same end of the cable as the transmitter.

The term TEXT' hereinafter refers to far-end crosstalk, this being crosstalk between two pairs in one cable measured at the other end of the cable as the transmitter.

The term ‘DMT’ hereinafter refers to discrete multi-tone technology, in which information is sent independently over a number of independent frequency bands or tones.

The term ‘channel’ refers to a connection conveying signals between a transmitter and a receiver. Channels may be unidirectional or bi-directional.

The term ‘bᵢ’ or bit loading refers to the amount of information transmission in a given bin, as measured in bits.

The term ‘gᵢ’ or gain refers to the power level in a given bin, as measured for instance in dBm.

The term ‘power spectrum density’ or ‘psd’ refers to the power as a function of sub-channel or frequency.

The term ‘margin’ refers to the difference between minimum necessary and actual signal to noise ratio in a channel. This may also refer to the difference between desired and actual signal to noise ratio in a channel.

The term ‘DSLAM's refers to digital subscriber line access multiplexers.

The term ‘latency’ refers to the time required for a given piece of data to be transmitted between two points.

The term ‘QoS’ or ‘quality of service’ refers to a measure of the information transmission quality of a transmission channel or line, such as bitrate, maximum latency, error rate, or the like.

The term ‘QoE’ or ‘Quality of Experience’ refers to a subjective measure of a customer's experiences with a service or with a vendor.

The term CPE' refers to customer premises equipment, such as a cable modem.

The term ‘plurality’ refers hereinafter to any positive integer e.g, 1, 5, or 10.

The term ‘MIMO’ hereinafter refers to ‘multiple input multiple output’ systems such as a cable containing a plurality of twisted pair copper wires, or such wires and modems associated with them.

The term ‘showtime’ hereinafter refers to active transmission periods of a transmission line, during which useful information is transmitted. In particular, it does not include calibration periods.

### The Missing Link

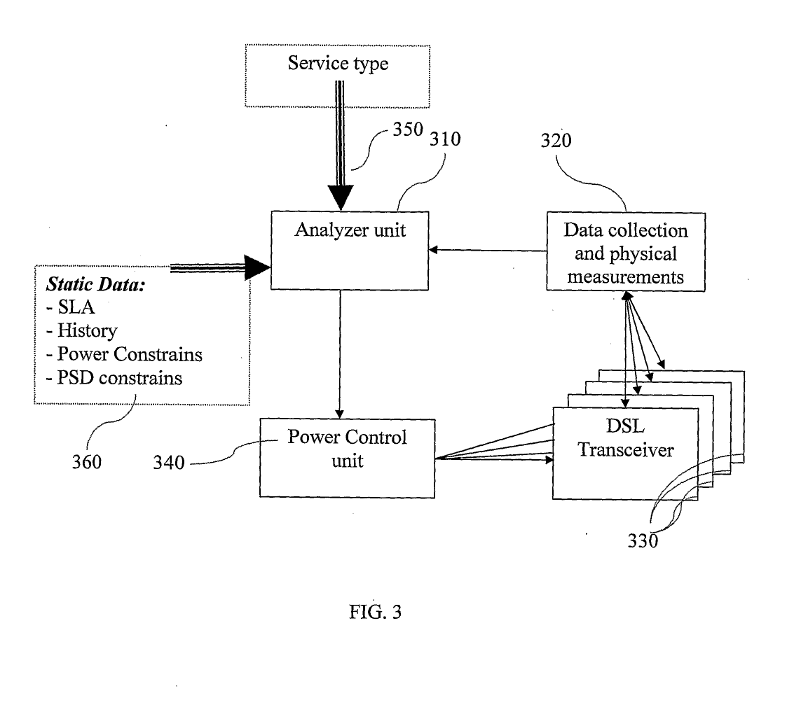

In the IP network different services receive different treatment (different priority, latency, etc.). In the physical layer of the access side things are much different. Although the DSLAM is provided with intelligent prioritization mechanisms at the abstract level, such prioritization is not fully implement in the actual physical layer of DSL services. Application specific handling in the physical layer is limited, in current DSL technology, into single-user implementations. For example, VDSL2 (ITU T G992.3) defines an inherent preemption mechanism that gives higher priority to latency-critical voice and video packets over other data packets such as e-mail messages and web access for a specific user. However, when a VDSL2 line is transferring only data packets, for example, the system ignores the possible interference that it is generating (due to crosstalk) on adjacent lines even though adjacent lines may be currently carrying sensitive video packets (for example). A better treatment would be to take both desired QoS and crosstalk for each line to arrive at a globally ‘best’ solution. For example, such a system might give the video line a margin-related priority over the data line. A margin related priority may be to reduce interference from line B, carrying data, into line A, carrying video conferencing data. This interference reduction may reduce the SNR in line B while improving SNR on line A, such that the necessary QoE for each individual line is maintained. FIG. 3 shows a basic component used for implementing a control system of the current invention. Operational data of DSL transceivers 330, as well as physical parameters, such as crosstalk, are collected by a centralized unit 320. These parameters, as well as other inputs, such as static data 360, are used by analyzer unit 310 in order to find an optimal power-related working point for the DSL transceiver.

It is a key innovation of the invention to use dynamic application-specific data 350 in addition to static data 360 to arrive at global optima for service quality. Such dynamic data give the analyzer 310 capability to further optimize power-related parameters of modems 330 without degradation in QoS of provided services. Power control unit 340 receives power-related parameters from analyzer 310 and is responsible for changing the working-points (i.e. margin-related parameters) of moderns 330. The working points are sometimes defined in terms of the bitloading bᵢ, and gain gᵢ for each bin i and for each line j, written as (bᵢ,gᵢ)ⱼ

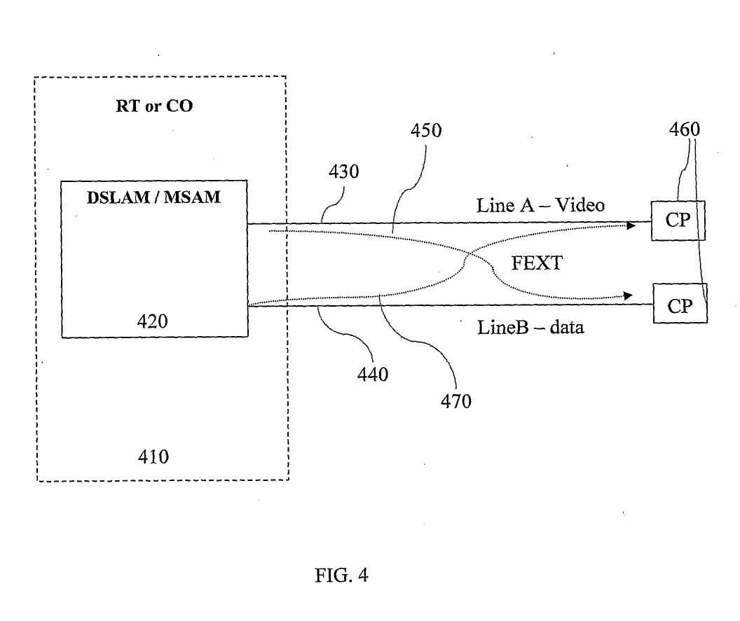

FIG. 4 shows an example of two DSL lines, one carrying video and one carrying data (lines (430) and (440) respectively). Both lines interfere with each other through FEXT (450 and 570). Without knowledge of the application content on each line, a “naïve” L2 DSM system will find a sub-optimal working point, since it does not take into account the different necessary QoS on each line. Furthermore, in some cases (when SNR on lines is very low due to high levels of environmental noise) the DSM system won't find any stable working-point for these lines, and at least one line will suffer from instability (in turn leading to disconnections) or poor QoS.

In contrast, by employing the method of the current invention and taking into consideration the application on each line, the DSM may find a better working-point for both lines such that QoS on lines will be maintained as required. As in the example of FIG. 4, the DSM system may operate line A with higher SNR, by increasing its PSD in all or several bins. This power increase will improve the QoS on line A. Although this will also definitely increase noise in line B (due to FEXT mechanism), the additional BER on this line could be set adequate for the specific service it carries (in this example—data).

Alternatively, if SNR in line B is higher than the minimum needed SNR to obtain the required QoS, power on line B may be reduced in all or several bins in a say such that SNR in line A will increase and QoS on line A will improve.

In a preferred embodiment of the invention, the type of traffic in a given channel is determined, as a prerequisite for implementation of the rest of the system. The differentiation between different types of traffic may be performed using new as well as existing methods and architectures in the network and in the DSLAM, such as VLAN, MPLS and others.

For example, VLAN uses a priority field with a number from 0 to 7, as does MPLS. In the header of IP traffic there is a ‘type of service’ field with 256 potential values (though the DSCP standard only uses 6 of the 8 bits). These architectures can be used separately or in combination to determine which type of traffic is most important. For example, providers may add service VLAN tags, or map IP-based TOS into VLAN- or MPLS-based priorities.

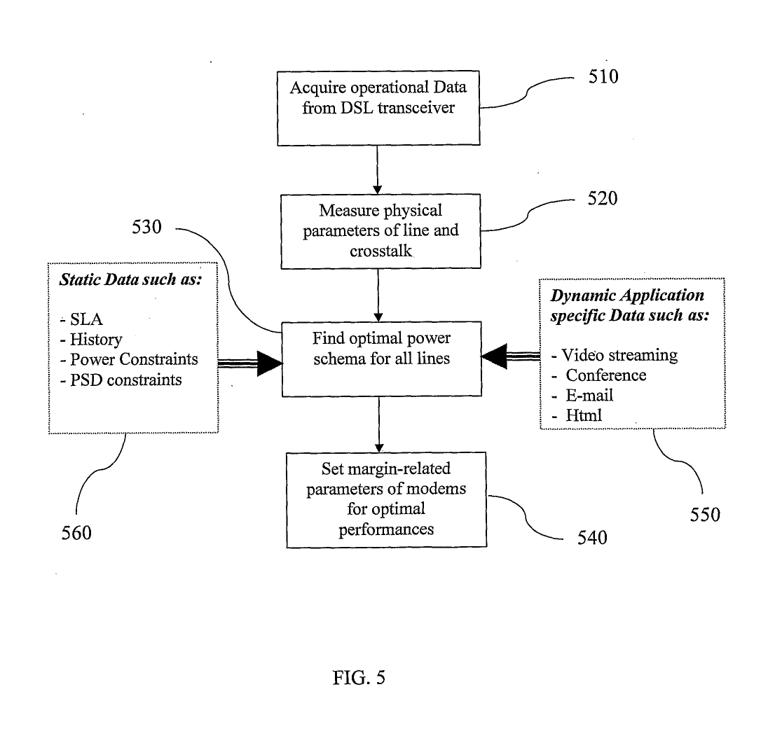

The method of the current invention can be combined with existing DSM methods in order to achieve further margin-related optimization. As an example, FIG. 5 illustrates a DSM system, which benefits both from prior art methods (such as static data knowledge 560) as well as the method of the current invention (illustrated as use of dynamic application-specific data 550). In this figure, a general overview of the method of the current invention is shown in block-diagram form. This figure provides an example of DSM system flow that uses both crosstalk measurement and dynamic application-specific data. Operational data of DSL modems are acquired (510) from modems. Then a physical measurement of crosstalk between lines and other required parameters are performed (520). The crosstalk measurement can be performed using method suggested in this invention (as will be detailed bellow), or any other method. Furthermore, crosstalk values as well as other physical measurements may be imported from external measurement results, which are not part of the DSM system. Using operational data and physical parameters of line, optimal working-point for all lines is evaluated (530). The analysis used in (530) takes into consideration additional static data (560). Static data are so called since they are rarely changed (like SLA, local and global power/PSD constrains, parameters history of lines, etc). In addition, as suggested by the current invention, block (530) also uses application-specific data (550). These data are so-called “dynamic” as they are continuously changing. User may watch a video film, or perform a voice conversation, while downloading files from the internal, etc. After evaluating new operational working point for all modems, required margin-related parameters (or so-called working point) are set to the modems by block (540).

### Power Saving Methods

As mentioned above, overall quality of service improvements can be realized by reducing power on highly interfering channels. Thus a parallel technique for overall QoS optimization exploits power consumption reduction. This has added benefits as power consumption is gaining focus not only due to the increasing cost of energy, but also due to raising awareness to environmental considerations. Many governments and organizations put this issue at the head of their priority list (EU commission-JRC, ETSI, ITU-T, ENTO).

Generally, the line drivers consume over one-half of the power consumed by a typical DMT system. Chip designers are consistently improving power consumptions using, for example, methods to reduce PAR (Peak to Average Ratio) of a DMT signal. In addition, system solutions that reduce power consumption when a link does not have data to transmit have been suggested. Also methods to reduce power on certain bins in case that the requested data rate is less then maximum data rate achievable on the line, have been suggested (e.g. U.S. Pat. No. 6,259,746).

The current invention introduces an additional method in order to reduce average power consumption of the system. This method can be combined with existing methods in order to achieve further power reduction. By noting the different subscriber applications on various lines and giving each line a corresponding different margin-related metric, as previously described, total power consumption can be reduced.

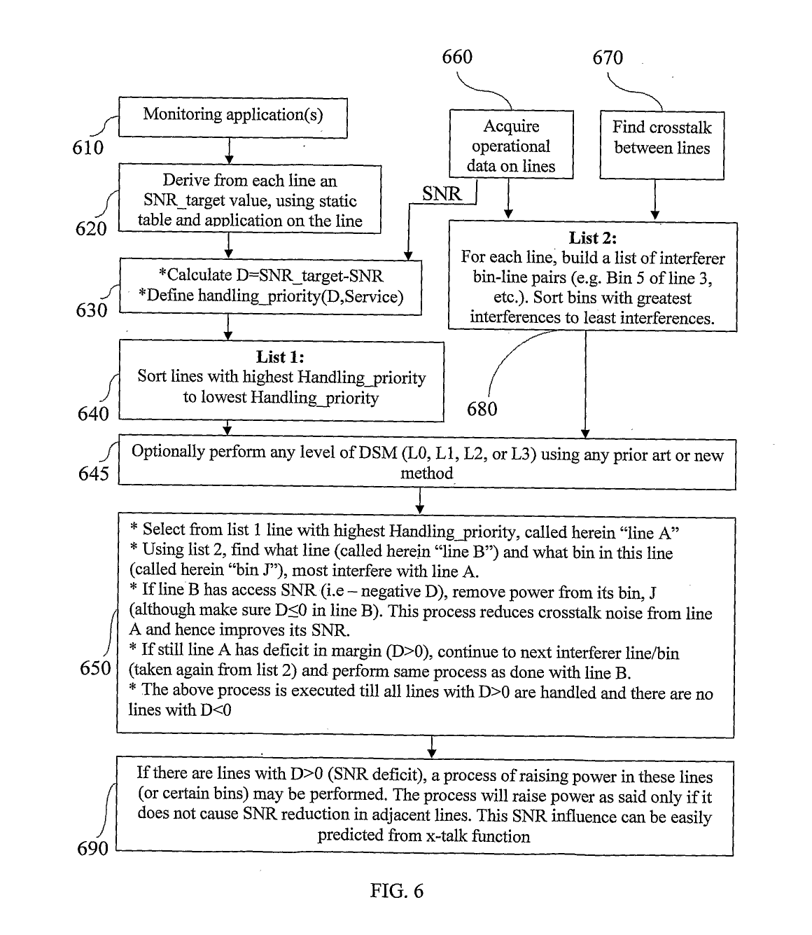

FIG. 6 shows an example of how to use the knowledge of application on lines, in order to implement an enhanced DSM system. Block (610) finds current application/s running on each line. This can be done by monitoring packets, or using indicators inside the DSLAM (e.g. VLAN tagging information, MPLS labels, etc.). Then, each line receives an SNR-target value (620). This value is extracted from pre-prepared static table. It reflects the required QoS for the application running on each line. Alternatively, (620) can import the required QoS on each line, from external real-time system that monitors QoS/QoE. Block (630) evaluates, for each line, the gap between desired SNR (SNR target) and actual SNR. Actual SNR can be extracted from modem or be estimated using theoretical tools. The gap, D, between SNRs may be either negative (and hence is better then minimal requirement for this line), positive (which imply that SNR on this line should be improved in order to achieve required QoS), or 0 (hence SNR on line is adequate for the application running on it). Next, ‘handling priority’ parameter is defined. This parameter is a function of the SNR gap, D, and the service on the line. For example, a higher ‘handling priority’ value may be set to line carrying video, compared with line carrying html service—even if line with html service has higher D value. Block (640) generates a sorted list of lines from highest ‘handling priority’ to lowest ‘handling priority’. This list will be used to tune lines such that all gaps on lines will be equal or lower than 0. Lines that are more sensitive to SNR requirement (i.e. high SNR target) will be handled first since first processed lines have more degree of freedoms and hence get higher priority in the competition on the bandwidth.

Blocks 660 and 670 collect operational data on lines and crosstalk between lines, respectively. A 2nd list is generated (680) that contains, for each line, interferer bins and their associated line. For example, assuming that line #2 suffers from high crosstalk in bin #130, injected by line #7. Furthermore, line #2 also suffers from a slightly lower crosstalk in bin #53 from line #3. Then, in the list, first interferer will be bin #130/fine #7, 2nd interferer will be bin #53/line #3, etc. Such bin list is build for all managed lines.

Then, Dynamic Spectrum Management (DSM) of any kind and any level (L0, L1, L2, L3) can be optionally incorporated in the process. The DSM process may also use operational data and crosstalk measurements extracted from block 660 and 670 respectively.

Finally, the method reduces interference into lines with deficit in SNR (as sorted in list 1) by reducing transmit power in those lines that most interfere. The power reduction may be performed for example only on bins that most interfere (as sorted in list 2). Furthermore—it is within provision of the invention that power reduction will be performed on a given bin only if its associated line has excess SNR (in accordance with list 1).

The process of selective-bins interference reduction is repeated for all lines with SNR deficit. It will be evident to those skilled in the art that this process improves margin on lines, beyond that possible with the regular prior art DSM system. The improvement of this invention is gained in addition to performances reached by DSM system. Note that if after the process described in FIG. 6, the SNR requirements in at least one bin of at least one line is not met (i.e D>0), and the maximal power limitation of the system has not been exceeded, it is within provision of the invention to increase power in those bins on lacking SNR. In one embodiment this mechanism may be increasing power on bins that least interfere adjacent lines (690). It is within provision of the invention that other measures besides SNR be considered and optimized using the technique described above. For example, latency, BER, and vector-valued functions may be used in place of or in addition to SNR.

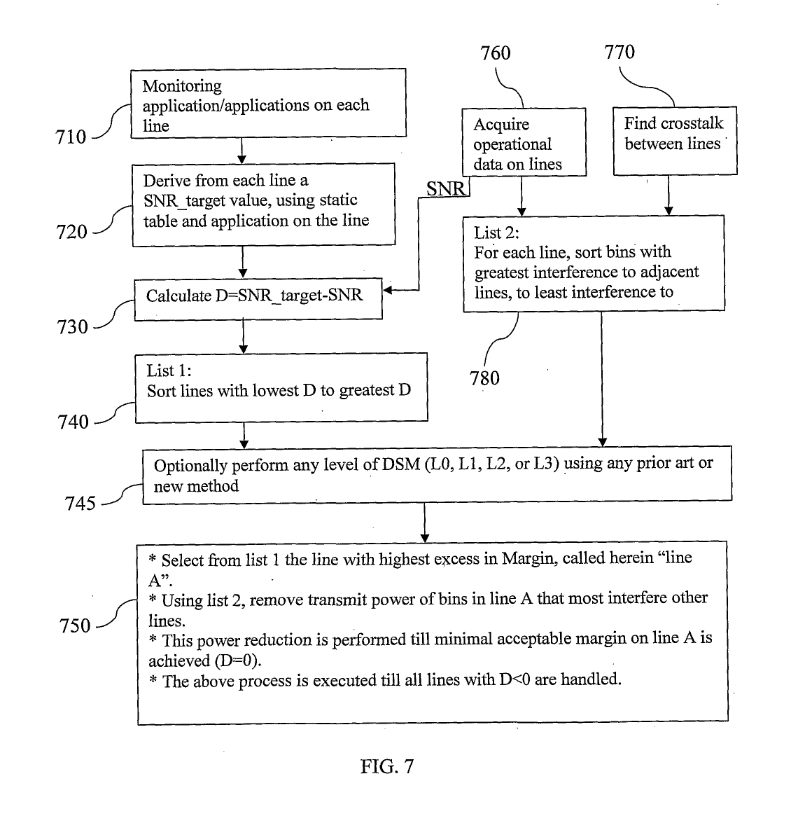

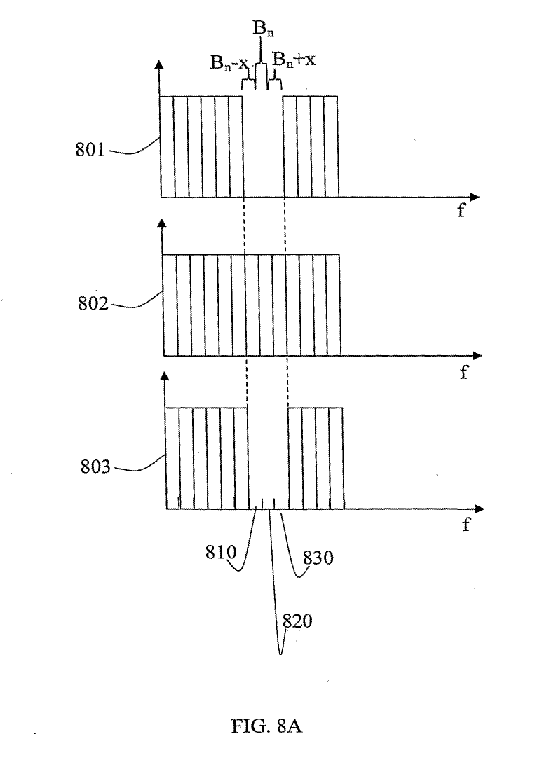

FIG. 7 shows an example of how to reduce the total transmitted power using knowledge of application on the lines and crosstalk between lines. In this example, the total power consumption is minimized such that the overall QoE, considering all lines, is maintained. Block (710) finds current application/s running on each line. Then, as was described in FIG. 6, each line receives a SNR-target value (720), and the difference between desired SNR (SNR_target) and actual SNR is calculated (730). Next, a sorted list with lines where gap <0 is generated (740). The power on these lines can be reduced as long as their actual SNR is higher then SNR_target (i.e- Minimal required QoS on these lines can be achieved while reducing power on these lines). Blocks 760, 770, are identical to blocks 660, and 670 (respectively), described in FIG. 6. List2 is generated (780) by sorting, for each line, bins with greatest interference to other adjacent lines.

Any prior-art DSM process can be optionally incorporated (745). Starting from line with greatest excess SNR (from list1), power is systematically reduced (750). The power reduction is first performed on bins which most affect adjacent lines (as listed in list2). Note that if after the process described in FIG. 7 SNR in at least one line is not met (i.e D>0), and maximal power limitation of system was not exceed, there should be a mechanism that increase power on this line. In one embodiment this mechanism may be increasing power on bins that least interfere adjacent lines.

It should be noted that the process described in FIG. 6 (650) and FIG. 7 (750) can be either performed iteratively by controlling the modems and measuring the reaction to the changes, or by theoretically predicting the influence of the process, using mathematical, inferential, experimental, or theoretical models. These may involve machine learning (AI) or other algorithmic methods as will be obvious to one skilled in the art.

Since applications on each line are changing, the power consumption for each line is dynamically controlled depending on the subscriber's current application. Due to the dynamic nature of application-specific data, the entire process as described e.g. in FIGS. 6,7 is preferably repeated continuously at a rate satisfying requirements of system response rate, or when the system detects that the active service on a particular line has changed.

Those skilled in the art will readily appreciate that using SNR criteria as described in FIGS. 6 and 7 can be easily replaced by other criteria such as BER, Margin, or other QoS/QoE related measures.

The invention can also be used in order to reduce total average power consumption of the DSLAM/MSAM, by dynamically controlling transmit power on lines such that applications with less tight realtime requirements will be carried with less margin, while sensitive applications will receive better SNR in order to give the subscriber the required QoS.

### Crosstalk Measurement

There are several methods for measuring crosstalk-coupling functions among pairs, such as US 20050213714. The methods involve transmitting a known signal on one pair and receiving the signal on the other pairs. For most cases the cross talk measurements need to be performed while the pairs carry no service, thus assuring a monitored and quiet environment.

Nevertheless there are some methods that enable measuring crosstalk on cables populated with services. In cases where there are active services on the lines, the cross talk coupling transfer function measurements can be very difficult to perform accurately. The SNR is sometimes not good enough for measuring the low PSD levels of crosstalk while other much stronger signals and possibly other sources of interference are present.

There are algorithms that use the active services defined signals on the pairs during initialization state for measuring the signals on adjacent pairs using correlation. Such a method that uses a periodic training signal such as REVERB periodic sequence is described in article “Real-time Fext crosstalk identification in ADSl systems” [Nikolaos Papandreou and Theodore Antonakopoulos 2003 IEEE].

While these methods are fast and relatively easy to implement they need high SNR in order to be accurate and further they need a management system that will enable a pair's initialization stage to be detected and synchronize with the affected pair measurement process. Alternatively the management system may use another method for detecting the initialization stage of a new service. This method also does not enable monitoring of crosstalk changes while a modem is in active use. Another limitation of this method is the ability to distinguish and analyze low cross talk levels that affect the measured pair. In an actual cable other interfering lines will generally be present, thus limiting the ultimate sensitivity of crosstalk measurement.

The present invention suggests means for measuring crosstalk by using a centralized management unit that at a given time shuts down bin or a number of bins for transmission on all active modems. These will be referred to as the ‘test bins’, and a specific modem whose crosstalk is to be checked will be referred to as the ‘modem under investigation’. This can be done for example by using a BIN BLACKOUT message (for example as defined in standard ITU T G992.3) or other means provided by the modem—either covered by standard or a propriety solution. The centralized management unit further requests all modems (except for the modem under investigation) to listen (receive) on the test bins while the modem under investigation sends a signal on the test bins. This signal can be simple, for example a normal showtime PSD level, or an encoded signal tailored for measurement purposes. Uncontrolled interference will now originate only from any remaining unbundled DMT services (FIG. 3), non-DMT based services, and electromagnetic interference originating from outside the bundle. It is within provision of the invention to use cross correlation measurements for crosstalk measurement.

After the cross talk level is found for the test bins, the same check may be performed on other bins of the modem in question, or another modem may be put through the same procedure as the modem under investigation. In either case, the process is repeated till the cross talk levels for all bins and for all pair to pair couplings is found. This method is not limited to this sequence of measuring bins and pairs; other scanning orders can be performed, and furthermore particular bins and/or couplings may be skipped, for example in the case that these bins historically show no change, show little interference, or the like.

This method can be carried out while modems are in any stage of transmission including active transmission, and will not substantially affect the SNR levels or the bitrate of the system, since only a few bins are silenced or being used for the crosstalk measurement at any given time. The rest of the bins, for both transmitters and receivers, will still carry information at maximal rates. The method can be used for monitoring any changes in a pair's transmission quality, setting the cross talk coupling functions for a DSM system and more. Moreover since coupling functions are relatively stationary, cross talk need be tested only rarely, for example once upon new service installation and with infrequent periodic monitoring for changes (e.g. monthly), or upon request.

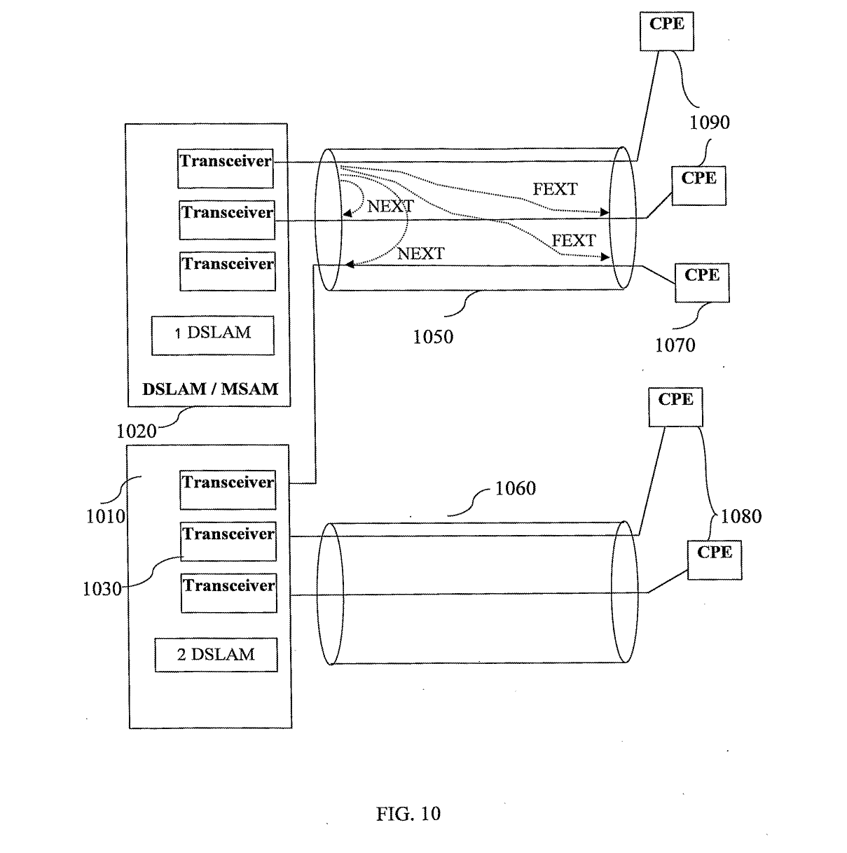

In another embodiment this suggested method could be further combined with the previous described methods such as using the correlation of initialization sequences for detection of crosstalk sourced in an ‘unbundled services scenario’ as in FIG. 10, which are not managed by a DSLAM or MSAM unit. In this way the unmanaged interferers can be measured with a higher SNR while the transition on the set of measured Bins for all managed moderns are shut down.

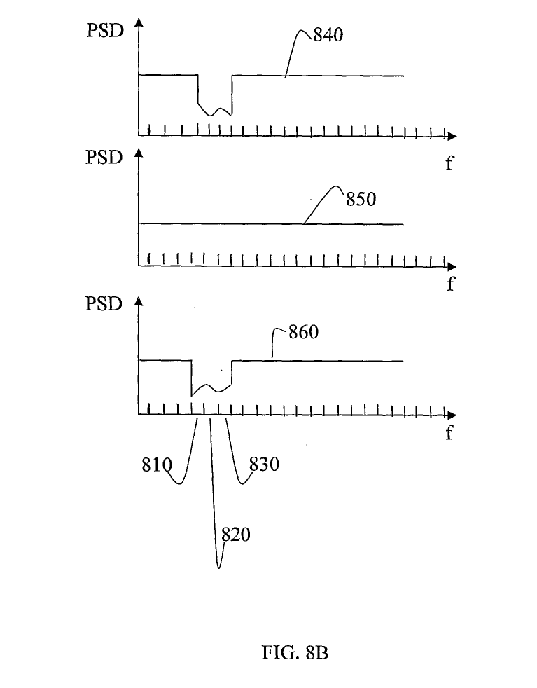

FIGS. 8-11 present the suggested crosstalk measuring method.

In FIG. 8a the notion of the bin blackout is shown. The sent (transmitted) frequency spectrum for three lines is shown, line 1 (801), line 2 (802), and line 3 (803). The bins 810, 820, and 830 have had their transmit power reduced to zero for lines 1 and 3. Channel B however is still transmitting at full power in these bins. By reducing power in line 1 and line 3 to zero in the bins 810,820,830 while keeping line 2 transmitting, the crosstalk from line 2 into line 1 and line 3 for these bins can be determined.

A range of X bins, on either side of the center bin Bn 820, may be used for faster cross talk measurement if an IBI guard is not needed and coarser measurement resolution is adequate for the application. In FIG. 8a, b the value of X is 1, that is a single bin (810,830) is used on either side of the center bin 820. After the black out process is done, Modem 2 transmits a known signal (860) or pattern on bin 820 if X is used as a guard band, or on the range 810-830 (Bn-X to Bn+X) if X is not used as a guard band. X can have any value between 0 and the maximum number of bins supported by the standard for the service. All other modems listen and measure the noise on the center bin Bn or on the range of bins from Bn-X to Bn+X.

The measurement now possible is shown in FIG. 8b, where the three channel's received frequency spectrum is shown. Line 1 (840) and 3 (860) have considerably less power in the blacked-out bins 810,820,830 since there is no transmission into these bins. However some small amount of power is still received in these bins, due inter alia to crosstalk from line 2 (850) which is the only line transmitting into these frequencies. Other sources may also cause part of the power measured in the blacked bins 810, 820, 830, such as harmonics of lower frequencies IBI (inter-band-interference) thermal noise, stray electromagnetic radiation, and the like.

The use of three bins 810, 820, 830 to be blacked out is a practical safeguard to increase the precision of the measurement; by blacking out a range of X bins both higher and lower than the bin 820 one actually desired to test, the noise measured in bin 820 on the blacked-out lines will be due to crosstalk from line B more and more accurately. Thus X is the number of bins use as a guard band for IBI reduction, or as a range of bins for a fast cross talk measurement.

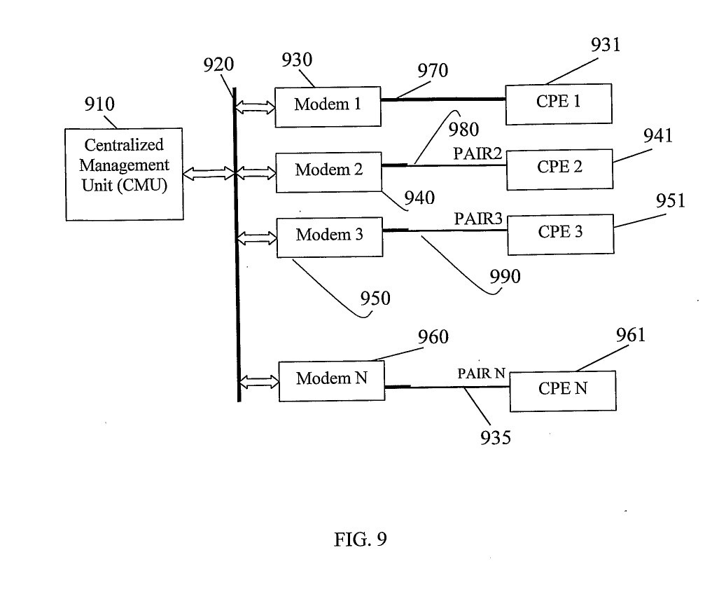

With reference to FIG. 9, we assume N modems in a cable or a binder, all or some controlled by a centralized management unit 910. The centralized unit 910 orders certain the bin blackout whereby bins of certain lines reduce or stop transmission of power. After all modems have taken a turn as the transmitting modem for a given bin (channel 2 for bin 820 of FIG. 8), the CMU (910) can order the same process to be done on the next bin. Obviously the process could be ordered differently, with the loop being performed over bins and then modems, instead of over modems and then bins.

NEXT coupling functions at DSLAM side will be found for example by performing the process among Modems (930,940,950,960).

NEXT coupling functions at CPE side will be found for example by performing the process among CPEs (931,941,951,961).

FEXT coupling functions at DSLAM side will be found for example by performing the process by transmitting on CPEs (931,941,951,961) one at a time and listening with DSLAM Modems (930, 940,950,960).

FEXT coupling functions at CPE side will be found for example by performing the process by transmitting on DSLAM moderns (930,940,950,960) one at a time, while listening with CPE Moderns (931,941,951,961).

The whole process ends when all coupling cross talk functions for all pairs and Bins are found both by the DSLAM modems (930,940,950,960) and by CPEs (931,941,951,961).

All cross talk data for the bin or range of bins measured is then saved in the centralized unit or at the modems. Then the CMU (910) indicate another modem to transmit, for example modem 3 (950) while all other modems (such as modem 2 (940)) listen on the line.

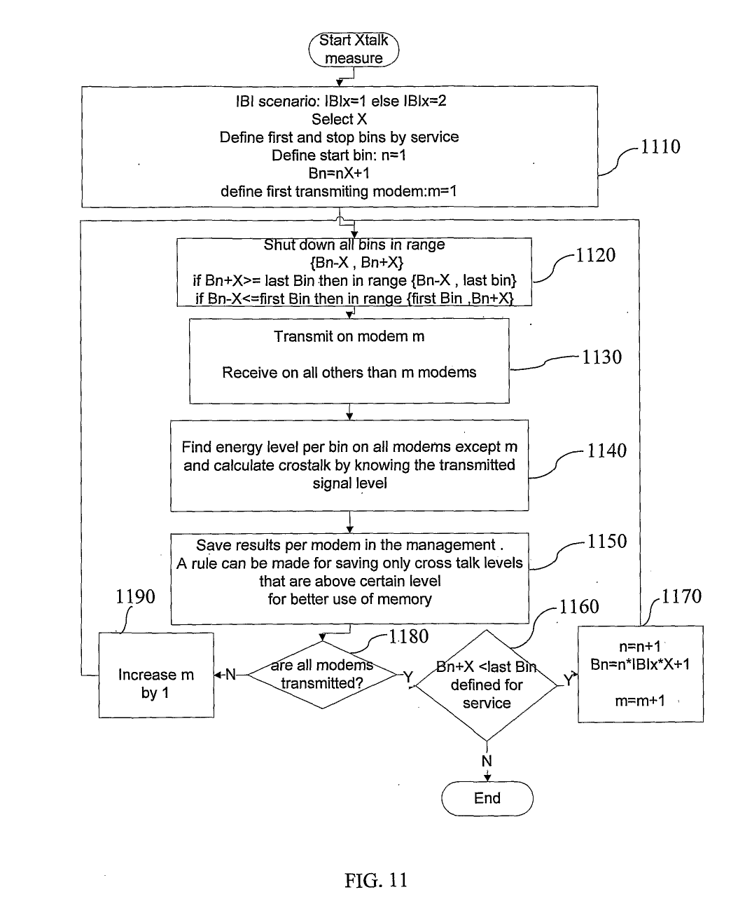

FIG. 11 presents the suggested crosstalk measuring method in flowchart form. The centralized unit orders Bins Bn-X to Bn+X to be blacked out (1120). X can have any value such that the range of blacked-out bins will be between 0 to the maximum number of bins supported by the standard for the service.

After the black out process is done, the identity m of the transmit modem can be set for example to 2 (1130). This causes modem 2 to transmit a known signal or pattern on bin Bn (if X is used as a guard band) or in the range Bn-X to Bn+X (if X is not used as a guard band).

All other modems listen and measure the noise on Bn or the range of bins Bn-X to Bn+X (1140).

All cross talk data for the bin (or range of bins) measured is then saved in the centralized unit or at the moderns (1150). Then the CMU chooses another modem (1180, 1190) to transmit for example modem 3 while modem 2 listens on the line. After all moderns have transmitted the cross talk couplings for the central bin Bn or the range of bins Bn-X to Bn+X are found. Then the CMU can order the same process to be done on the next bin, for example bin number Bn+1 or a corresponding range of bins (1160, 1170).

The whole process ends (1180, 1170) when all coupling cross talk functions for all pairs and Bins are found both by the DSLAM modems and by CPEs.

### Overview of Key Features of the Invention

The apparatus of the current invention controls SNR and PSD in a DSL modem pair to achieve optimal spectrum distribution in a telecommunications cable. The optimization is based on specific application traffic on the line.

The type of data traffic on each line is analyzed and categorized into groups whereas each group gets margin-priority rank. Ranks can be given according to several predefined criterion such as sensitivity of applications to BER, subscriber's package, and others.

Since the type of data on each line is dynamically changing (for example, when a subscriber finishes watching a movie and starts to download data from the web), the type of traffic is continuously monitored and ranked. Furthermore, data traffic for each subscriber may contain various applications simultaneously. In one embodiment of the invention, the subscriber's line is ranked according to its most BER-sensitive application. In another embodiment of the invention, the subscriber's line is characterized by a vector indicating BER sensitivity, latency requirements, and possibly other requirements or characteristics of the service(s) currently carried on the line.

The operational data and margin-related rank on lines are analyzed in order to find optimal spectrum distribution for each line. The analysis can be performed by a centralized controller, such as DSM center. Such controller may reside in the DSLAM/MSAM or as separate entity on the management network.

After the analysis, one or more modems will be set to use margin-related parameters or Per Bin margin vectors calculated by the analyzer. In one embodiment the margin-related parameter can be a new PSD vector for downstream and new PSD vector for upstream of the modern.

Due to the dynamic nature of subscriber's data application, traffic should be continuously monitored and re-evaluated. The monitoring frequency is implementation specific and is derived from the required response time of the margin-controlled parameter. From one side, the response time should be fast enough such that best overall bundle performance will be achieved. On the other hand, response time should not be too short in order to avoid unnecessary transient effects in the bundle. In addition, response time can vary depending on specific data traffic. For example, when new subscriber's application has requires better SNR, in order to support expected QoS for this application, the response time should be relatively fast. On the other hand, when new application require fewer margins, the response time is less critical to efficiently deliver the application.

Embodiments of the present invention can be used but not limited in connection with ADSL1, ADSL2, ADSL2+, VDSL2 and other types of DMT or OFDM based systems and equipment.

On yet another embodiment of the present invention, the margin-related parameters can be set in order to reduce overall DSLAM/MSAM power consumption. For example, the average transmit power may be reduced in order to reduce total power consumption, while the expected QoE of running applications are maintained.

As can be seen, mapping the crosstalk between lines in a bundle can be used to optimize the margin-related value. The current invention suggests accurate method for crosstalk measurement that can be performed during showtime without interfering with the on line service. Crosstalk measurement can be also used for various other purposes such as a partial line qualification system, DSM system, etc.

As will be obvious to one skilled in the art, the QoS, margin, and other transmission quality characteristics can be replaced with different measures of transmission quality. These can be referred to as metric functions. For example, metric function might be defined as the sum over all lines of the difference between actual and desired transmission rate. The desired transmission rate can be determined, for example, by reference to the application running on that line. Alternatively the metric could be defined as the sum over all lines of the difference between acceptable and actual error rate. Alternatively the metric could be defined as the total power used by transmission lines. Combinations of these metrics can also be used, and other alternative metrics will be obvious to one skilled in the art.

The problem of power allocation in a MIMO system can be viewed as an optimization problem, where the metric described above is the function to be optimized. Since this optimization problem is a function of many variables (the power in each bin on each line, the crosstalk values, and the line characteristics and application data) there may be many local maxima of the metric function. To deal with this phenomenon many techniques have been proposed and many of them will be applicable to the problem at hand. It is within provision of the invention to use any of these optimization techniques for the purpose of metric optimization. For example, gradient ascent, linear programming, nonlinear programming, derivative methods, combinatorial methods, genetic algorithms, and the like may all be employed.

1-21. (canceled)

22. A method of crosstalk reduction in a multiple input-multiple output (MIMO) packet of transmission lines comprising steps of:
a. collecting service data for each transmission line in said transmission line system;
b. collecting operational data for said transmission line;
c. defining a target value by using a method chosen from the group consisting of
i. defining a vector of target parameter values for each said transmission line based on service; and,
ii. determining for each line a maximum allowed bit error rate (BER) required to maintain adequate quality of service (QoS) on said line;
d. calculating a metric based on the difference between said target value and the actual parameter value for each said transmission line;
e. determining the crosstalk for each pair of said transmission lines; and
f. varying the transmitted power spectral density (PSD) at each frequency of each said transmission line to optimize said metric;
whereby said metric for said MIMO transmission line system is optimized taking into account said application data and said crosstalk.

23. The method of claim 22, wherein said varying the transmitted PSD is accomplished by means of an algorithm selected from the group consisting of: iteration, gradient descent, simplex, simulated annealing, quantum annealing, genetic algorithm, neural network, SVM, radial basis function, alpha-beta pruning, and interior point method.

24. The method of claim 23, wherein said step of varying the transmitted PSD for said transmit lines comprises steps of:
a. defining a target SNR value for each said transmission line based on said application data;
b. calculating the deficit between target and actual SNR values for each said transmission line;
c. for each line in order of largest to smallest deficit, reducing power in those bins of any other lines having deficit less than zero, without increasing the deficit of said other lines above zero;
whereby the deficit for each line in said MIMO transmission line system is reduced taking into account said application data.

25. The method of claim 24, where said method is used for power consumption reduction.

26. The method of claim 22, periodically repeating the entire method, whereby changes in service on lines can be taken into account.

27. The method of claim 22, wherein said step of determining the crosstalk for each pair of said transmission lines comprises steps of:
a. for each line under test in said transmission line system, selecting a set of blackout bins on said line under test;
b. decreasing transmit power to zero on said set of blackout bins on all lines except for said line under test in said MIMO transmission line system;
c. broadcasting a predetermined signal on said line under test in said bins under test;
d. measuring the received power on all lines except for said line under test in said MIMO transmission line;
e. repeating steps a-c for all lines in said MIMO transmission line system,
whereby crosstalk measurement is achieved during showtime with only a negligible decrease of total transmission rate on said transmission lines.

28. The method of claim 27, where said predetermined signal is selected from a group consisting of:
a showtime PSD level, a constant power level, and a periodically varying power level.

29. The method of claim 27, where said step of decreasing transmit power is accomplished by means selected from a group consisting of: a bin blackout message, a constant signal, or a time-varying signal.

30. The method of claim 27, providing a further step comprising importing crosstalk data from an external test measurement database.

31. The method of claim 27, providing a further step of using the embedded double-ended line test of one or more of said transmission lines.

32. The method of claim 22, where said step of determining the crosstalk for each pair of said transmission lines comprises a technique selected from the group consisting of: use of built in measurement functions available on one or more of said transmission lines; and use of external measurement data.

33. The method of claim 22, including an additional step of performing any level of dynamic signal management (DSM).

34. A system for reducing crosstalk in a MIMO transmission line system comprising:
a. means for collecting application data for each transmission line in said transmission line system;
b. means for collecting operational data for said transmission line;
c. crosstalk measurement means for determining the crosstalk for each pair of said transmission lines;
d. means for calculating a metric function of said application data, said operational data, and said crosstalk;
e. power control means for adjusting the transmit PSD for said transmission lines to maximize said metric function;
wherein application data is utilized in addition to operational and crosstalk data to maximize said metric function.

35. The system of claim 34, wherein said power control means comprises:
a. definitions of target SNR value for each said transmission line based on said application data;
b. means for calculation of the deficit between target and actual SNR values for each said transmission line;
c. a power controller adapted to reduce power in those bins of any other lines having deficit less than zero, without increasing the deficit beyond zero, for each line in order of largest to smallest deficit,
whereby the deficit for each line is said MIMO transmission line system is reduced taking into account said application data.

36. The system of claim 34, wherein said power control means comprises:
a. definitions of target SNR value for each said transmission line based on said application data;
b. means for calculation of the excess SNR for each bin of each line of said MIMO transmission line system;
c. a power controller adapted to reduce power in those bins having excess SNR, without reducing said SNR below zero, for each line in order of highest to lowest excess SNR;
d. whereby the crosstalk interferences in said MIMO transmission line system is reduced taking into account said application data.

37. The system of claim 34, wherein said means for determining the crosstalk for each pair of said transmission lines comprises:
a. means for selecting a set of bins under test on said line under test for each line under test in said transmission line system;
b. power control means adapted for decreasing transmit power to zero on said set of bins under test, on all lines except for said line under test;
c. broadcast means adapted for broadcasting a predetermined signal on said line under test in said bins under test;
d. power measurement means adapted for measuring the received power on all lines except for said line under test;
e. control means adapted for repeating steps a-c for all bins in said line, and for all lines in said transmission line system,
whereby crosstalk measurement is achieved during showtime with only a negligible decrease of total transmission rate on said transmission lines.

38. The system of claim 37, wherein said predetermined signal is selected from a group consisting of:
a showtime PSD level, a constant power level, and a periodically varying power level.

39. The system of claim 34, wherein said power control means is adapted to broadcast a bin blackout message.

40. The system of claim 34, further including means for performing any level of dynamic signal management (DSM).
